(19) United States
(12) Patent Application Publication
(10) Pub. No.: US 2026/0170510 A1
(43) Pub. Date: Jun. 18, 2026

(54) SYSTEMS AND METHODS FOR MULTIJURISDICTIONAL COMPLIANCE

(71) Applicant: C T Corporation System, New York, NY (US)

(72) Inventors: Abhishek Mittal, Clark, NJ (US); Amit Gupta, Haryana (IN); Rajiv Arora, Katy, TX (US); Varun Dixit, Pune (IN); Arvind Kumar, Pune (IN); Yogesh Kumar, Uttar Pradesh (IN)

(73) Assignee: C T Corporation System, New York, NY (US)

(21) Appl. No.: 18/978,906

(22) Filed: Dec. 12, 2024

(51) Int. Cl. G06Q 30/018; G06F 16/185

(52) U.S. Cl. CPC G06Q 30/018; G06F 16/185

(57) ABSTRACT

Systems and methods for processing and evaluation of electronic documents are disclosed. A digital twin machine learning model is trained using a product taxonomy, a criteria knowledge base, and previous applications of the criteria to previous sets of digital files. A set of digital files is received and image processing is applied to the set of digital files to identify contents in each of the set of digital files. The set of digital files is analyzed using the digital twin machine learning model to identify one of a set of completion criteria to evaluate the set of digital files. For each of the set of digital files determine the classification in accordance with the product taxonomy and determine whether the digital file has a required classification. In response to determining a document does not meet completion criteria, identification of a required action for satisfying the document completion criteria is displayed.

### TECHNICAL FIELD

This application relates generally to digital twin machine learning models, and more particularly, to the use of digital twin machine learning models to evaluate sets of digital files for categorization, digital file completeness, and set completeness.

### BACKGROUND

Evaluation of sets of digital files, e.g. documents, for legal compliance, requires a substantial amount of human expertise. For example, evaluating a set of digital documents, for completeness in accordance with regulatory requirements, requires knowledge of the regulatory rules and of the types of documents required. Such knowledge of the regulatory requirements is complicated by the existence of a high number of regulations. For example, more than one thousand sets of different regulatory requirements may exist for a single transaction type, given that many such regulations are promulgated and enforced by jurisdictions as small as an individual county. Additionally, such knowledge is easily expired, as regulatory requirements evolve and/or accepted document forms change, over time and across jurisdictions.

In one example, a set of digital files, e.g. documents, is required by U.S. states and/or localities in order to make a recognized change to the ownership of a registered motor vehicle. Each jurisdiction has its own requirement for which document classifications must be present for the transaction to be approved, and each document classification that is required has its own criteria, e.g. rules or regulations, regarding which information, e.g. fields, of the document must be completed for the document to be considered complete. These requirements are often not codified, and understanding of thereof may be completed in some instances only via practical experience. Accordingly, knowledge in these areas is presently unstructured, distributed, and difficult to replicate.

The process of evaluating these documents is a heavily localized, manual labor and human knowledge intensive process. It would be advantageous to structuralize the localized jurisdictional knowledge so the analysis of the documents, both for document completeness and set completeness, can be automated.

### SUMMARY

In various embodiments, a system configured to apply a digital twin model for multijurisdictional compliance via a dynamic, self-updating taxonomy based on real-time analysis of changing regulations is disclosed. The system includes a non-transitory memory and a processor communicatively coupled to the non-transitory memory. The processor is configured to read a set of instructions to train a digital twin machine learning model. The digital twin machine learning model represents a physical asset configured to process digital files and apply criteria. The digital twin machine learning model is trained using a product taxonomy, a criteria knowledge base, and previous applications of the criteria to previous sets of digital files. The processor is further configured to receive a set of digital files to determine whether the set of digital files meets one of a plurality of set completeness criteria. Each of the plurality of set completeness criteria includes digital file classification presence criteria and digital file completeness criteria. The processor is further configured to apply image processing to the set of digital files to identify contents in each of the set of digital files and analyze the set of digital files, using the digital twin machine learning model. Analyzing the set of digital files includes identifying, using the contents of at least one digital file in the set of digital files, one of the plurality of set completion criteria to evaluate the set of digital files. For each of the set of digital files, the processor is configured to determine, using the digital twin machine learning model, the classification of the respective digital file in accordance with the product taxonomy based on the content or metadata from the respective digital file and determine, using the digital twin machine learning model, based on the digital file classification presence criteria associated with the classification, whether a digital file having the classification of the digital file is required. Upon a determination that a digital file having the classification of the digital file is required, the processor is configured to determine whether the digital file meets the digital completeness criteria for the classification, based on the contents of the respective digital file as identified by the image processing. In response to a determination that the respective digital file does not meet document completion criteria, the processor is configured to display on a user interface an identification of a required action for satisfying the document completion criteria. The processor is further configured to determine, using the digital twin machine learning model, whether the set of digital files meets the one of the plurality of set completion criteria, including determining whether a digital file having each classification for which digital classification presence criteria are required is present and meets digital file completeness criteria for the classification. Upon a determination that the plurality of digital files does not meet the one of the plurality of set completion criteria, the processor is configured to display on a user interface an identification of a rationale detailing why the set of digital files did not meet the one of the plurality of set completion criteria and, upon a determination that the plurality of digital files meets the one of the plurality of set completion criteria, the processor is configured to create an output reflecting that the set of digital files is complete.

In various embodiments, a computer-implemented method configured to apply a digital twin model for multijurisdictional compliance via a dynamic, self-updating taxonomy based on real-time analysis of changing regulations is disclosed. The computer-implemented method includes a step of training a digital twin machine learning model. The digital twin machine learning model represents a physical asset configured to process digital files and apply criteria and the digital twin machine learning model is trained using a product taxonomy, a criteria knowledge base, and previous applications of the criteria to previous sets of digital files. The computer-implemented method further includes a step of receiving a set of digital files to determine whether the set of digital files meets one of a plurality of set completeness criteria. Each of the plurality of set completeness criteria includes digital file classification presence criteria and digital file completeness criteria. The computer-implemented method further includes steps of applying image processing to the set of digital files to identify contents in each of the set of digital files and analyzing the set of digital files, using the digital twin machine learning model. Analyzing the set of digital files includes identifying, using the contents of at least one digital file in the set of digital files, one of the plurality of set completion criteria to evaluate the set of digital files. For each of the set of digital files, the computer-implemented method includes steps of determining, using the digital twin machine learning model, the classification of the respective digital file in accordance with the product taxonomy based on the content or metadata from the respective digital file and determining, using the digital twin machine learning model, based on the digital file classification presence criteria associated with the classification, whether a digital file having the classification of the digital file is required. Upon a determination that a digital file having the classification of the digital file is required, the computer-implemented method includes a step of determining whether the digital file meets the digital completeness criteria for the classification, based on the contents of the respective digital file as identified by the image processing. In response to a determination that the respective digital file does not meet completion criteria, an identification of a required action for satisfying the completion criteria is displayed on a user interface. The computer-implemented method includes a step of determining, using the digital twin machine learning model, whether the set of digital files meets the one of the plurality of set completion criteria, including determining whether a digital file having each classification for which digital classification presence criteria are required is present and meets digital file completeness criteria for the classification. Upon a determination that the plurality of digital files does not meet the one of the plurality of set completion criteria, an identification of a rationale detailing why the set of digital files did not meet the one of the plurality of set completion criteria is displayed on a user interface. Upon a determination that the plurality of digital files meets the one of the plurality of set completion criteria, an output reflecting that the set of digital files is complete is created.

In some embodiments, a non-transitory computer readable medium having instructions stored thereon is disclosed. The instructions, when executed by at least one processor, cause at least one device to perform operations configured to apply a digital twin model for multijurisdictional compliance via a dynamic, self-updating taxonomy based on real-time analysis of changing regulations. The operations include training a digital twin machine learning model. The digital twin machine learning model represents a physical asset configured to process digital files and apply criteria and the digital twin machine learning model is trained using a product taxonomy, a criteria knowledge base, and previous applications of the criteria to previous sets of digital files. The operations further include a step of receiving a set of digital files to determine whether the set of digital files meets one of a plurality of set completeness criteria. Each of the plurality of set completeness criteria includes digital file classification presence criteria and digital file completeness criteria. The operations further includes steps of applying image processing to the set of digital files to identify contents in each of the set of digital files and analyzing the set of digital files, using the digital twin machine learning model. Analyzing the set of digital files includes identifying, using the contents of at least one digital file in the set of digital files, one of the plurality of set completion criteria to evaluate the set of digital files. For each of the set of digital files, the operations include steps of determining, using the digital twin machine learning model, the classification of the respective digital file in accordance with the product taxonomy based on the content or metadata from the respective digital file and determining, using the digital twin machine learning model, based on the digital file classification presence criteria associated with the classification, whether a digital file having the classification of the digital file is required. Upon a determination that a digital file having the classification of the digital file is required, the operations include a step of determining whether the digital file meets the digital completeness criteria for the classification, based on the contents of the respective digital file as identified by the image processing. In response to a determination that the respective digital file does not meet completion criteria, an identification of a required action for satisfying the completion criteria is displayed on a user interface. The operations include a step of determining, using the digital twin machine learning model, whether the set of digital files meets the one of the plurality of set completion criteria, including determining whether a digital file having each classification for which digital classification presence criteria are required is present and meets digital file completeness criteria for the classification. Upon a determination that the plurality of digital files does not meet the one of the plurality of set completion criteria, an identification of a rationale detailing why the set of digital files did not meet the one of the plurality of set completion criteria is displayed on a user interface. Upon a determination that the plurality of digital files meets the one of the plurality of set completion criteria, an output reflecting that the set of digital files is complete is created.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide image processing and evaluation of sets of digital files in accordance with multijurisdictional rules, in accordance with some embodiments;

FIG. 2 illustrates a computer system configured to implement one or more processes, in accordance with some embodiments;

FIG. 3 is a flowchart illustrating a state of the art method prior to the present disclosure;

FIG. 4 illustrates an exemplary user interface for criteria creation, in accordance with some embodiments;

FIGS. 5A-5B illustrate an exemplary user interface for displaying results of document data extraction in accordance with some embodiments;

FIG. 6 illustrates an exemplary user interface for displaying results of document analysis in accordance with document completeness criteria and/or set completeness criteria, in accordance with some embodiments;

FIGS. 7A-7C are a flowchart illustrating a digital file analysis method, in accordance with some embodiments;

FIG. 8 illustrates an artificial neural network, in accordance with some embodiments;

FIG. 9 illustrates a tree-based artificial neural network, in accordance with some embodiments;

FIG. 10 illustrates a deep neural network (DNN), in accordance with some embodiments;

FIG. 11 is a flowchart illustrating a training method for generating a trained machine learning model, in accordance with some embodiments; and

FIG. 12 is a process flow illustrating various steps of the training method of FIG. 11, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for image processing and automated evaluation of sets of digital files in accordance with multijurisdictional rules. In various embodiments, one or more electronic documents are received. The electronic documents may include electronic images of non-electronic documents. The electronic documents are processed, for example, via image processing, and validated for use in one or more transactions. Validation may include application of a trained digital twin model to verify compliance with one or more jurisdictional requirements. A corresponding jurisdiction may be identified from extracted document data by the digital twin model. In some embodiments, systems and methods for image processing and evaluation of sets of digital files in accordance with multijurisdictional rules includes the use of one or more trained digital twin machine learning models. A digital twin model may include a machine learning model that provides a virtual representation that provides a real-time digital counterpart of a physical asset. The digital twin model is designed to mirror and/or predict behavior of the physical asset through data analysis and simulation.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

In various embodiments, neural networks which are trained (e.g., configured or adapted) to generate outputs, such as updates to a graphical user interface, data elements to support submission of documents to a third party for evaluation, etc., are disclosed. A neural network trained to generate outputs, such as updates to a graphical user interface, data elements to support submission of documents to a third party for evaluation, etc. may be referred to as a trained digital twin machine learning models. A trained digital twin machine learning model may be configured to receive a set of input data, apply image processing and evaluation of sets of digital files in accordance with multijurisdictional rules, and output final jurisdiction-specific documents for submission.

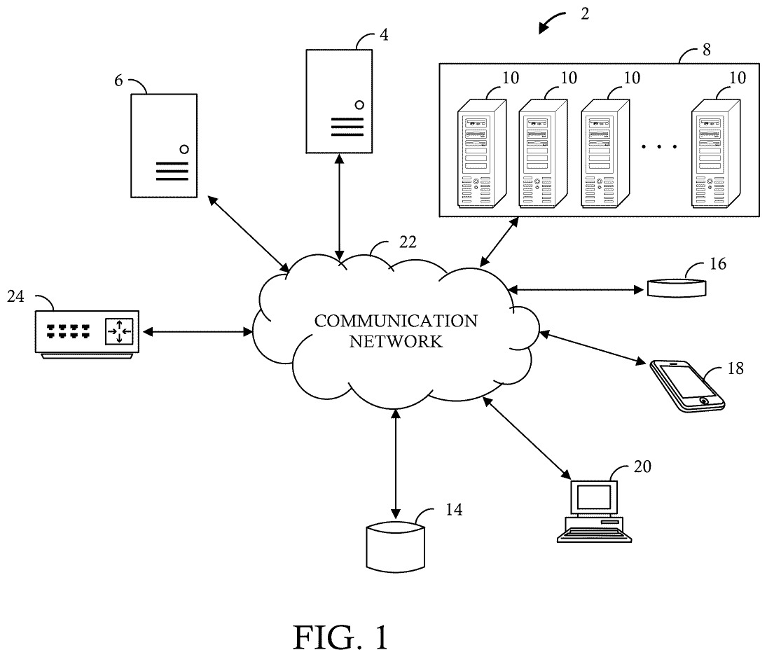

FIG. 1 illustrates a network environment 2 configured to provide image processing and evaluation of digital files in accordance with multijurisdictional rules, in accordance with some embodiments. The network environment 2 includes a plurality of devices or systems configured to communicate over one or more network channels, illustrated as a network cloud 22. For example, in various embodiments, the network environment 2 may include, but is not limited to, an image processing and evaluation computing device 4, a web server 6, a cloud-based engine 8 including one or more processing devices 10, a database 14, and/or one or more user computing devices 16, 18, 20 operatively coupled over the network 22. The image processing and evaluation computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the image processing and evaluation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the image processing and evaluation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an electronic document management network environment. In some embodiments, the image processing and evaluation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

Although FIG. 1 illustrates three user computing devices 16, 18, 20, the network environment 2 may include any number of user computing devices 16, 18, 20. Similarly, the network environment 2 may include any number of the image processing and evaluation computing device 4, the web server 6, the processing devices 10, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the image processing and evaluation computing device 4, the web server 6, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view data for elements associated with and displayed on the website, and click on interface elements presented via the website. The website may capture these activities as user session data, and transmit the user session data to the image processing and evaluation computing device 4 over the communication network 22. The website may also allow the user to interact with one or more of interface elements to perform specific operations, such as selecting one or more elements for further processing.

In some embodiments, the image processing and evaluation computing device 4 may execute one or more models, processes, or algorithms, such as a machine learning model, deep learning model, statistical model, etc., to provide for image processing and evaluation of sets of digital files in accordance with multijurisdictional rules. The image processing and evaluation computing device 4 may transmit interface elements associated with processed electronic documents to the web server 6 over the communication network 22, and the web server 6 may display interface elements associated with image processing and evaluation results on the website to the user.

The image processing and evaluation computing device 4 is further operable to communicate with the database 14 over the communication network 22. For example, the image processing and evaluation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the image processing and evaluation computing device 4, in some embodiments, the database 14 may be a local storage device, such as a hard drive, a non-volatile memory, or a USB stick. The image processing and evaluation computing device 4 may store interaction data received from the web server 6 in the database 14. The image processing and evaluation computing device 4 may also receive from the web server 6 user session data identifying events associated with browsing sessions, and may store the user session data in the database 14.

In some embodiments, the image processing and evaluation computing device 4 generates training data for a plurality of models (e.g., machine learning models, deep learning models, statistical models, algorithms, etc.) based on document data, multijurisdictional rules, knowledge-based data, etc. The image processing and evaluation computing device 4 and/or one or more of the processing devices 10 may train one or more models based on corresponding training data. The image processing and evaluation computing device 4 may store the models in a database, such as in the database 14 (e.g., a cloud storage database).

The models, when executed by the image processing and evaluation computing device 4, allow the image processing and evaluation computing device 4 to perform image processing and evaluation of sets of digital files in accordance with multijurisdictional rules. For example, the image processing and evaluation computing device 4 may obtain one or more models from the database 14. The image processing and evaluation computing device 4 may then receive, in real-time from the web server 6, an one or more electronic images and/or documents for processing. In response to receiving the electronic images and/or documents, the image processing and evaluation computing device 4 may execute one or more models to process and evaluate sets of digital files in accordance with multijurisdictional rules.

In some embodiments, the image processing and evaluation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the image processing and evaluation computing device 4 may generate interface elements configured to display processing and/or evaluation results for one or more electronic documents.

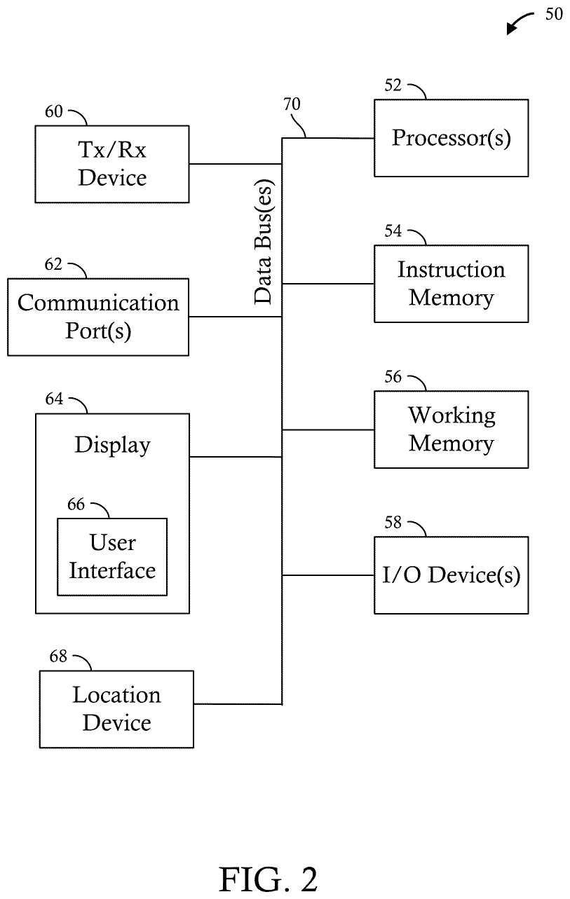

FIG. 2 illustrates a block diagram of a computing device 50, in accordance with some embodiments. In some embodiments, each of the image processing and evaluation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for image processing and evaluation of sets of digital files in accordance with multijurisdictional rules, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

Several types of transactions are often highly document intensive. The kinds of documents required to effectuate the transaction are often still in the format of paper forms and other paper formatted documents. These paper formatted documents may be filled out on physical paper and then scanned to digital formats, e.g. PDF. Paper formatted documents may also be or include documents that are formatted as PDFs (e.g., in 8.5×11 or other traditional paper size layouts) and filled out electronically, e.g. on computers. In either case, the digital files to effectuate the transaction are, largely, still formatted like paper. Accordingly, they are also often reviewed by hand, by a human reviewer. Financial transactions that require third party approval to be effectuated are especially document intensive, specifically paper-formatted-document intensive. Third party approval may include approval by one or more governmental entities.

Additionally, any type of transaction that requires third party approval is subject to criteria, e.g. legal or regulatory rules, relating to required documents. Although rules vary in type and scope, they may, for purposes of discussion herein, be divided into two large categories. A first category may be described as set completeness criteria. Set completeness criteria may relate to whether a set of documents is complete. Set completeness criteria may include, but is not limited to, a list of types, or classifications, of documents, that are required to be present in a set for the set to be complete.

A second category may be described as document completeness criteria. Document completeness criteria may include rules relating to whether a single document contains the information it is required and/or expected to contain. Document completeness criteria may relate, for example, to certain fields in the document that must be filled out, e.g. if the document is a pre-formatted form. Document completeness criteria may also include criteria relating to whether an answer in a given field of a given document is a valid answer to the field. Document completeness criteria may exist for some or all of the classifications of documents that are required to be present pursuant to set completeness criteria.

Set completeness criteria and/or document completeness criteria may vary in accordance with which specific third party's or parties' approval is required for the transaction to be completed. For example, when a governmental body's approval is required, set completeness criteria and document completeness criteria may relate to the specific government, e.g. jurisdiction, whose approval is required. Set completion criteria and/or document completeness criteria may relate to different agencies within a single jurisdiction. For example, in the United States, some transactions may require federal agency approval, approval by an agency of a state government, and/or approval by an agency of a local government. In The United States, there are 50 states, plus the District of Columbia, with more than 1,800 county governments. Corresponding agencies (e.g., a department of motor vehicles) within each of these jurisdictions may have different set completion criteria and/or different document completion criteria. Furthermore, different agencies within the same jurisdiction may have different set completion criteria and/or different document completion criteria. A single transaction may require approval from one or more agencies across one or more governments. Furthermore, none of the criteria are static, and the criteria for any agency or jurisdiction may change at any time.

Knowledge surrounding set completion criteria and/or document completion criteria relating to different agencies of different jurisdictional governments, e.g. in the United States, is, in the present state of the art, largely unstructured. Knowledge relating to set completion criteria and/or document completion criteria is held largely by human beings, specifically those who may be specialists relating to a particular agency, a particular jurisdiction, a particular industry, class of transaction, or the like. These human beings with unstructured knowledge are therefore required for internal review of document sets, prior to submission to the third party for approval. The need for human beings with unstructured knowledge results in a manual labor-intensive process for receiving sets of documents and determining when they are ready for submission for approval. This labor intensive process requires a localized tracking of fulfillment workflow and operational metrics.

One industry where approval is controlled by small footprint local governments, transactions are numerous, and rules are fluid, is the process for governmental approval for transfers of, and liens on, motor vehicles. The remainder of the disclosure hereof will make reference to specifics relating to transactions of this nature. However, persons having skill in the art will understand that the disclosure hereof can be used in other industries, for other kinds of transactions, for other kinds of required document set compliance rules, and the like.

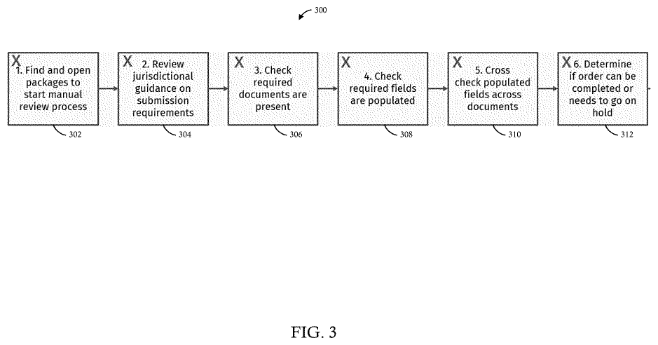

FIG. 3 is a flow diagram illustrating a human intensive process 300 for evaluating documents for submission, in accordance with the state of the art prior to the disclosure hereof. The process may be used by one party to a transaction to determine whether documents should be submitted to a required third party evaluator (e.g., a government agency) for approval.

At step 302, a package of digital documents relating to either a new lien, a lien release, or an ownership transfer for a motor vehicle is received. In this example, a local department of motor vehicles must record the lien or title, so that the new lienholder or title holder will be able to exercise his/her/its rights over the vehicle. At step 304, jurisdictional guidance on submission requirements may be reviewed. The review may occur by a human actor with relevant knowledge. At step 306, a human actor may check if required documents are present, in accordance with knowledge of set completion criteria. This check may include evaluating each document to determine its classification. At step 308, the human actor checks if required fields are populated and, at step 310, a cross-check of populated fields across documents may be completed. Cross-checking may be done to ensure consistency of information across documents in a set of documents. Cross-checking may also be done to ensure that populated fields in each document are populated with valid answers. At step 312, a determination is made whether the documents are compliant and ready for submission to the third party evaluator, e.g., the government agency, for independent evaluation.

In accordance with the present disclosure, the human centric process 300 of FIG. 3 may be replaced by an automated process that uses a digital twin and structured knowledge base including a product taxonomy. The process of using a digital twin may employ workflow, taxonomy, cognitive rules, advanced classification, and metadata extraction models, some or all of which may be used to conduct thorough data quality checks for fulfillment purposes.

By creating a “digital twin” incorporating jurisdictional subject matter expertise, the systems and methods presently disclosed establish an automated system to authenticate and populate documents in a manner that aligns with the requirements of various jurisdictions at all levels. In some embodiments, scalable artificial intelligence services, such as Azure Cognitive Services, may be leveraged. Accordingly, a platform in accordance with the present disclosure can more efficiently handle high volumes of data and can be tailored to support diverse use cases.

The systems and methods disclosed herein provide processing of scanned and digital document copies, accurate classification of the respective forms the documents represent, and verification of the presence of all necessary documents and/or materials within a document. As the pages of documents are classified, metadata may be extracted from the forms to ensure the precision of the document content for successful submission. A customized workflow solution utilizes AI capabilities to provide more efficient order process tracking and chain of custody on paper formatted documents files. In some embodiments, a digital twin model may also automatically populate forms with accurate submission information to improve order fulfillment and/or document fidelity to provide a streamlined, accurate, and expedited completion process. In some embodiments, the systems and methods of the present disclosure may reduce processing time, e.g, for motor vehicle liens, by about 45%, and may reduce rejections, as compared to prior human intensive methods, by about 50%.

In some embodiments, disclosed systems for document processing and evaluation may have two-parts. The system may begin with a taxonomy map where a jurisdiction's forms may be translated into a structured hierarchical format. The structured hierarchical format may be used to map the forms based on the relevant jurisdiction or agency to which they are related, for example. In further embodiments, a system in accordance with the present disclosure may also translate unstructured knowledge into a codified structure including rules and/or determination based on document type, fields and cross validation between documents. Unstructured knowledge may include knowledge gained via process documentation and may also include knowledge gained by personal experience.

Prior to the present disclosure, taxonomies were stored using pdf documents which required manual sorting into folders. Every rule had to be checked and updated for each pdf document or class of documents. A relevant document may contain required fields and may be limited to certain valid entries within one or more fields. An exemplar document may have been created for every required form, for every jurisdiction, and comparison of the exemplar to the form in any given set of documents was a manual process. In some embodiments, prior exemplar forms may have been annotated with notes which allow a manual reviewer to evaluate a form similar to the exemplar for compliance with rules relating to the exemplar. Exemplars may have been needed, under prior procedures, for guidance for each required document classification in accordance with rules for each jurisdiction or agency.

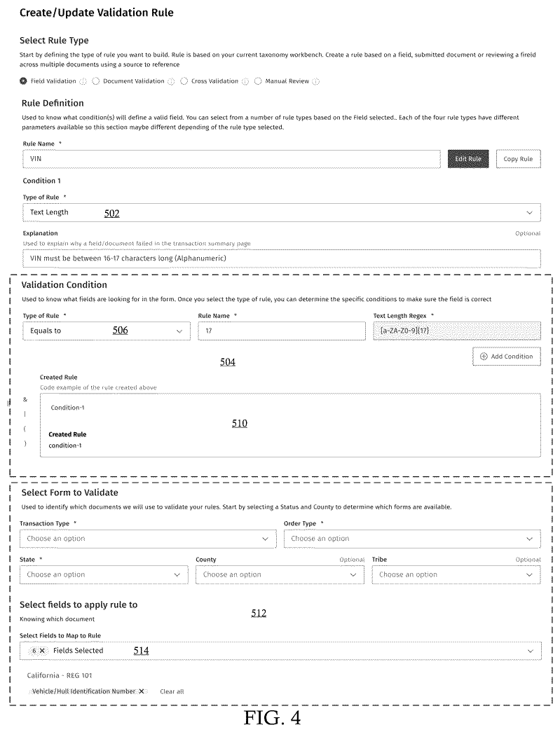

FIG. 4 is an exemplar of a user interface 500 for creating new rules in accordance with one embodiment of the present disclosure. In some embodiments, user interface 500 provides for definition of one or more validation rules to be applied to received electronic documents. User interface 500 may include a rule type field 502. Rule type field 502 may include radio buttons to enter a rule type, as shown, or may include other comparable user interface elements such as a pull down box. Rule types may include field validation, document validation, cross validation, or manual review. User interface 500 may also include a rule definition interface 504, which may include a plurality of fields 506 to define a rule. Fields 506 may include a rule name, one or more conditions, and an explanation. One or more conditions may include a type field, which may require information relating to the type of rule, such as text length. A Validation Condition interface 508 may contain additional fields 506, which may include certain validation conditions that determine whether the rule is met. For example, for an “equals to” rule, a response in a field may be required to equal a stated value. Other kinds of rules may include kinds of entries (e.g., letters, numbers), length of entries, and the like.

A created Rule interface 510 may include a visual representation of the rule being created in user interface 500, to help the user of the rule creation form visualize the logic of the rule being created, e.g. in a visual pseudo-code interface. The visual representation may be automatically generated from the entries in fields 506 in, e.g., rule definition interface 504 or validation condition interface 508.

A “Select Form to Validate” interface 512 may include identification of one or more forms, or document classifications, to which the rule will apply. Fields 506 in select to validate interface 512 may include transaction type and order type. Fields 506 may also include identifying fields for the agency or jurisdiction relating to the rule, e.g. state, county, tribe. Select fields to apply rule to interface 514 may allow a user to select fields to which a rule applies, e.g. from a list of fields known to exist in the form chosen in select form to validate interface 512.

In some embodiments, a taxonomy of multijurisdictional rules may be built from iterations of manual completions of forms such as user interface 500. As discussed in more detail below, a taxonomy may be defined and/or kept up to date via artificial intelligence models which may be trained using previous executions of one or more models on different sets of documents.

When a package or set of electronic documents is received, a trained digital twin may perform image processing on the documents. Image processing may include optical character recognition. In some embodiments, electronic documents, such as scanned images of documents, may be identified based on image processing and applied taxonomies and/or other applied rules or models. Image processing and data extraction may include the use of trained extraction algorithms. Data extraction may also use large language model (LLM) techniques.

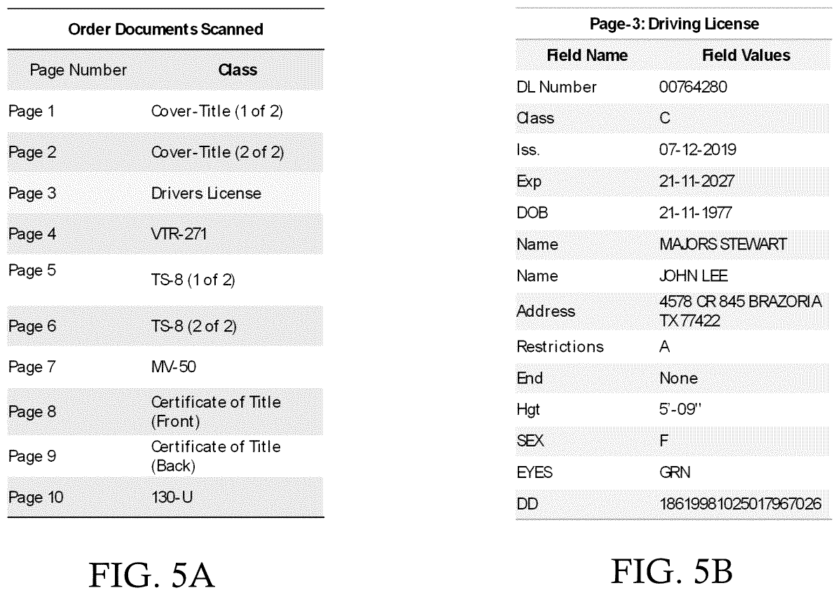

The identification of electronic documents may be presented via a user interface such as that shown in FIG. 5A. FIG. 5A shows the results of the model, which may identify title documents, a drivers' license, a certificate of title, and various forms. These identifications may be made without human intervention, using the application of the artificial intelligence model to the content extracted via image processing on each page of received electronic documents.

As shown in FIG. 5A, page 3 of the package of documents has been identified as a drivers license. Individual fields may also be identified, such as shown in FIG. 5B, wherein drivers license number, class, dates of birth, issue and expiration, address, driving restrictions, height, sex, and eye color have been extracted from the driver's license via image processing. A digital twin artificial intelligence model may also be used to identify a jurisdiction, for example, from the content of one or more electronic documents. For example, the presence of a form VTR-271 or a TS-8, as identified by the digital twin model, may identify the transaction as an automobile lien add in a particular Texas county. This analysis by the digital twin model provides for correct application of the jurisdiction specific set of rules or criteria.

Once documents and fields are recognized, and a jurisdictional identification is conducted, completeness analysis may occur. Completeness analysis may be performed in accordance with a knowledge base corresponding to jurisdictional knowledge for the previously identified jurisdiction. Set completeness criteria may be applied first. Identified document names, e.g. as shown in FIG. 5A, may be analyzed by the digital twin model to determine whether there are any document types that are required and/or expected for the identified jurisdiction but which are not present in the set of identified documents. A notification may be automatically generated in response to determining that one or more required and/or expected documents are missing.

In some embodiments, a digital twin model may evaluate the documents under document completeness criteria, without regard to whether set completeness criteria passes or fails. In other embodiments, document completeness criteria may only be run on complete sets. Document completeness criteria may include field validation, document validation and/or cross validation criteria. Document completeness criteria may evaluate the fields extracted from the document to determine whether they meet the jurisdictional requirements for documents of the same classification for the specific jurisdiction that was previously identified.

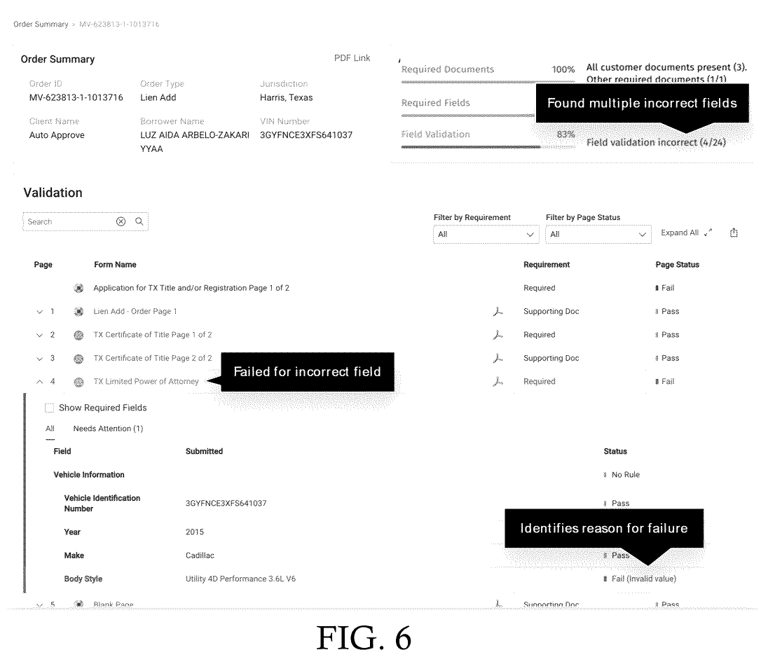

An exemplary user interface showing such information is shown in FIG. 6. As shown in FIG. 6, a generated interface may include a summary of how many documents (as shown, 83%) passed field validation criteria. For example, in a “validation” section, the first entry, “Application for TX Title and/or Registration Page 1 of 2” is shown as having failed a document completeness criteria, because it is not present. As another example, “TX Limited Power of Attorney” failed for an incorrect field in accordance with a field validation criterion. Also, the document that is in a “fail” status may allow a user to click for a more detailed look at why the document failed. As yet another example shown in FIG. 6, a cross-check criterion identified that an entry for “body style,” in one of the submitted documents was an invalid entry, because it an “invalid value.” This may be due to the entry not being one of a set of limited choices, a length rule, etc. In some embodiments, the user interface, as shown in FIG. 6, provides an intuitive dashboard that presents document analysis results, highlighting areas of non-compliance and suggesting corrective actions, thereby facilitating easier navigation and quicker decision-making by the user.

In some embodiments, different documents in the same jurisdiction may be linked together, e.g. using a graph, if, for example, the two documents have a common field, permitting the system to use cross-validation rules and/or checks to ensure that two documents having the same field also have the same entry in that field in both documents. In some embodiments, the user interface of FIG. 6 may provide an interaction ability to click a link and be taken to a document, e.g. a document that has failed one or more validation checks. In some embodiments, a user may be able to execute a link that will bring up the exact field that caused the document to fail a validation check. The ability to hot link to individual fields may, in some embodiments, be enabled by document tagging. Document tagging may occur when a document goes through image processing and data extraction. For example, when a field is identified via data extraction, the location of that field in the document may be tagged and stored, e.g. in the knowledge base or another data store, so that the system can locate the field at a later time, e.g., when the corresponding field is linked to a validation failure and needs to be corrected or otherwise altered.

When a package of documents is identified as having met all requirements for the relevant jurisdiction and/or agency, the system may then facilitate delivery of the documents to the agency. In some instances, the agency may reject the package, despite the system having identified the package as compliant. In that instance, the digital twin model may evaluate the rejection to determine whether rules in the taxonomy of rules need to be updated, and may, in some embodiments, update the rules accordingly.

Identification of the interface elements as shown in FIGS. 4, 5, and 6, associated with document intensive review can be burdensome and time consuming for users, especially if the documents are untagged or not pre-evaluated for compliance with completeness rules. Typically, a user may locate information regarding the set of documents by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding what fields may be missing from a document in a set.

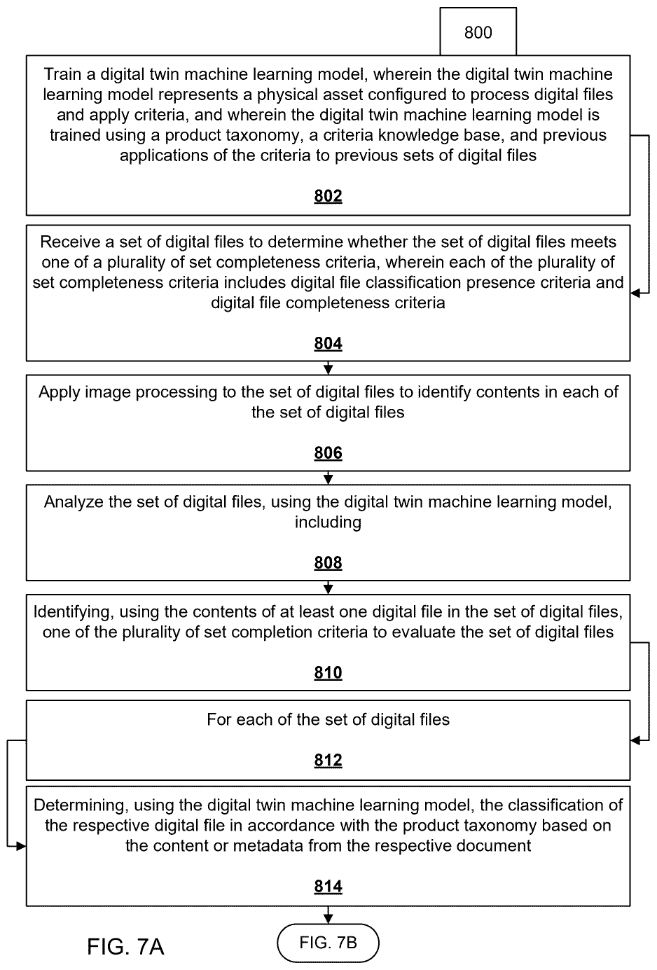

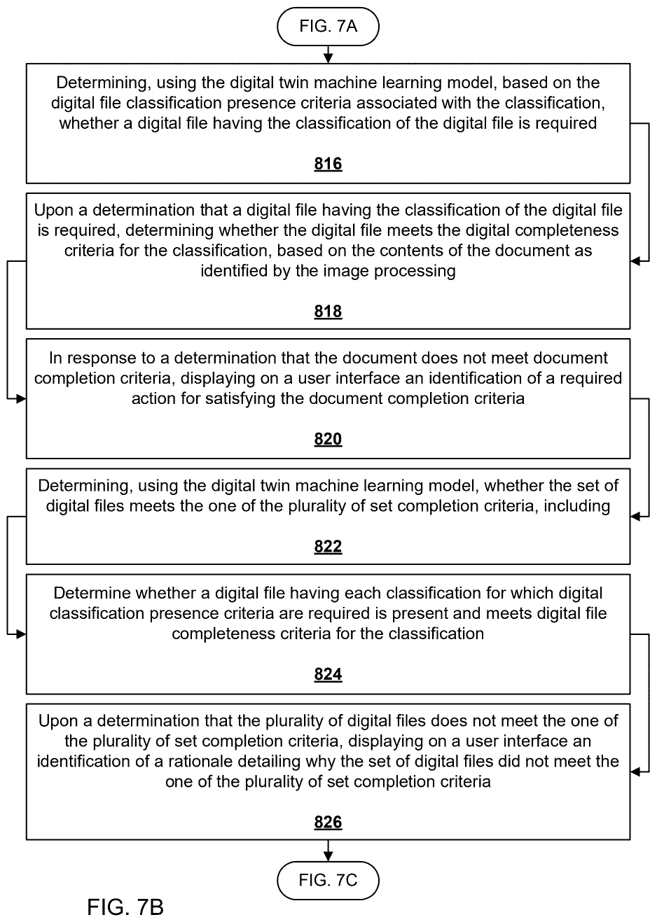

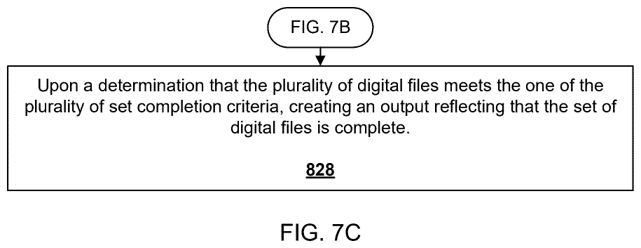

Turning now to FIG. 7A-7C, a flowchart in accordance with some embodiments of the present disclosure is illustrated. A method 800 includes training (802) a digital twin machine learning model, wherein the digital twin machine learning model represents a physical asset configured to process digital files and apply criteria, and wherein the digital twin machine learning model is trained using a product taxonomy, a criteria knowledge base, and previous applications of the criteria to previous sets of digital files. The physical asset, in some embodiments, may be or include a human reviewer of similar data. In some embodiments, a product taxonomy organizes digital files into a hierarchical structure based on their content and purpose. In some embodiments, a criteria knowledge base contains a repository of rules and regulations specific to various jurisdictions that may be updated at predetermined intervals (e.g., quarterly) to reflect regulatory changes. Unlike traditional compliance models, which statistically apply fixed rules, the disclosed digital twin machine learning models dynamically adapt to regulatory changes by integrating real-time data feeds from applicable databases (such as legislative databases), thereby ensuring up-to-date compliance and analysis.

The method 800 further includes receiving (804) a set of digital files to determine whether the set of digital files meets one of a plurality of set completeness criteria, wherein each of the plurality of set completeness criteria includes digital file classification presence criteria and digital file completeness criteria. The disclosed systems and methods adapt to varying compliance requirements by, in some embodiments, employing a modular approach wherein different sets of rules may be quickly swapped and/or applied depending on a corresponding jurisdiction. Automated application of completeness criteria on a jurisdictional basis significantly reduces the time needed for regulatory reviews as compared to traditional processes. The method 800 further includes applying (806) image processing to the set of digital files to identify contents in each of the set of digital files. Image processing may also include content extraction and field tagging as described above. The method 800 further includes analyzing (808) the set of digital files, using the digital twin machine learning model. The analyzing includes identifying (810), using the contents of at least one digital file in the set of digital files, one of the plurality of set completion criteria to evaluate the set of digital files. The analyzing further includes, for each of the set of digital files (812), determining (814), using the digital twin machine learning model, the classification of the respective digital file in accordance with the product taxonomy based on the content or metadata from the respective document, and determining (816) using the digital twin machine learning model, based on the digital file classification presence criteria associated with the classification, whether a digital file having the classification of the digital file is required.

For each of the set of digital files, the method further includes, upon a determination that a digital file having the classification of the digital file is required, determining (818) whether the digital file meets the digital completeness criteria for the classification, based on the contents of the document as identified by the image processing. The method further includes, in response to a determination that the document does not meet document completion criteria, displaying (820) on a user interface an identification of a required action for satisfying the document completion criteria.

The method further includes determining (822), using the digital twin machine learning model, whether the set of digital files meets the one of the plurality of set completion criteria, including: determining (824) whether a digital file having each classification for which digital classification presence criteria are required is present and meets digital file completeness criteria for the classification. Upon a determination that the plurality of digital files does not meet the one of the plurality of set completion criteria, the method further includes displaying (826) on a user interface an identification of a rationale detailing why the set of digital files did not meet the one of the plurality of set completion criteria. The method further includes, upon a determination that the plurality of digital files meets the one of the plurality of set completion criteria, creating (828) an output reflecting that the set of digital files is complete.

Systems including trained digital twin machine learning models, as disclosed herein, significantly reduce this problem, allowing users to locate deficient sets of documents, deficient specific documents, and/or deficient fields within documents, with fewer, or in some case no, active steps. For example, in some embodiments described herein, when a user is presented with a set of documents for a transaction, each interface element includes, or is in the form of, a link to an interface page for reviewing the evaluation of the document, and in some instances the document or field itself. Each recommendation thus serves as a programmatically selected navigational shortcut to an interface page, allowing a user to bypass the navigational structure of the browse tree. Beneficially, programmatically identifying documents and fields that fail rules and presenting a user with navigations shortcuts to these tasks may improve the speed of the user's navigation through an electronic interface, rather than requiring the user to page through multiple other pages in order to locate the portions of the package that may prevent it from being ready for submission, via the browse tree or via a search function. This may be particularly beneficial for computing devices with small screens, where fewer interface elements are displayed to a user at a time and thus navigation of larger volumes of data is more difficult.

It will be appreciated that content extraction, tagging, and rule updating, as disclosed herein, particularly on large datasets intended to be used with the disclosed embodiments/to generate trained models used in the disclosed embodiments, is only possible with the aid of computer-assisted machine-learning algorithms and techniques, such as large language models, digital twin models, or the like. In some embodiments, machine learning processes including large language models, digital twin models, or the like are used to perform operations that cannot practically be performed by a human, either mentally or with assistance, such as image processing and evaluation of sets of digital files in accordance with multijurisdictional rules. It will be appreciated that a variety of machine learning techniques can be used alone or in combination to generate or update the taxonomy, knowledge base, or document content extraction and tagging as disclosed herein.

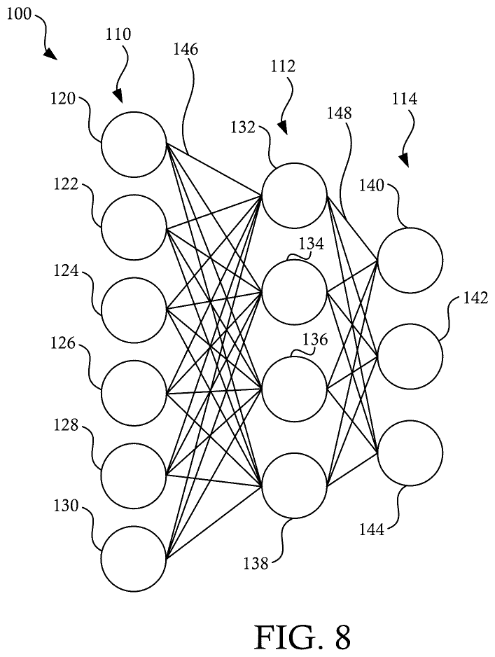

FIG. 8 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here,

$${x}_{i}^{( n )}$$

denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined for the weight

$${w}_{i , j}^{( n , n + 1 )} .$$

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers

$${δ}_{j}^{( n )}$$

may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on

$${δ}_{j}^{( n + 1 )} ,$$

if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and

$${y}_{j}^{( n + 1 )}$$

is the comparison training value for the j-th node of the output layer 114.

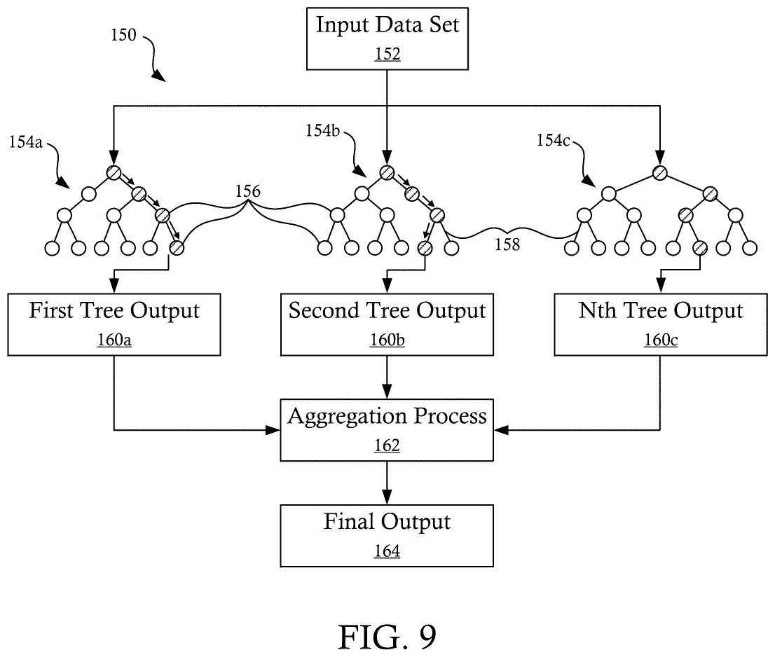

FIG. 9 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

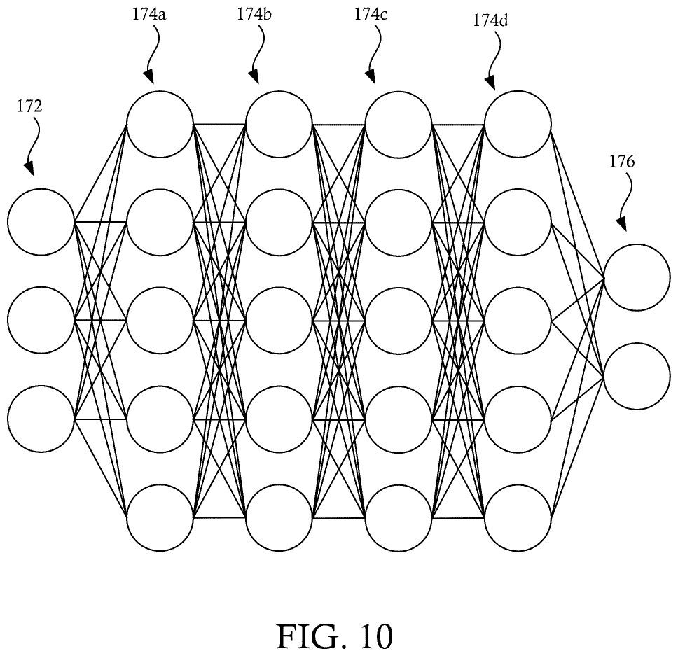

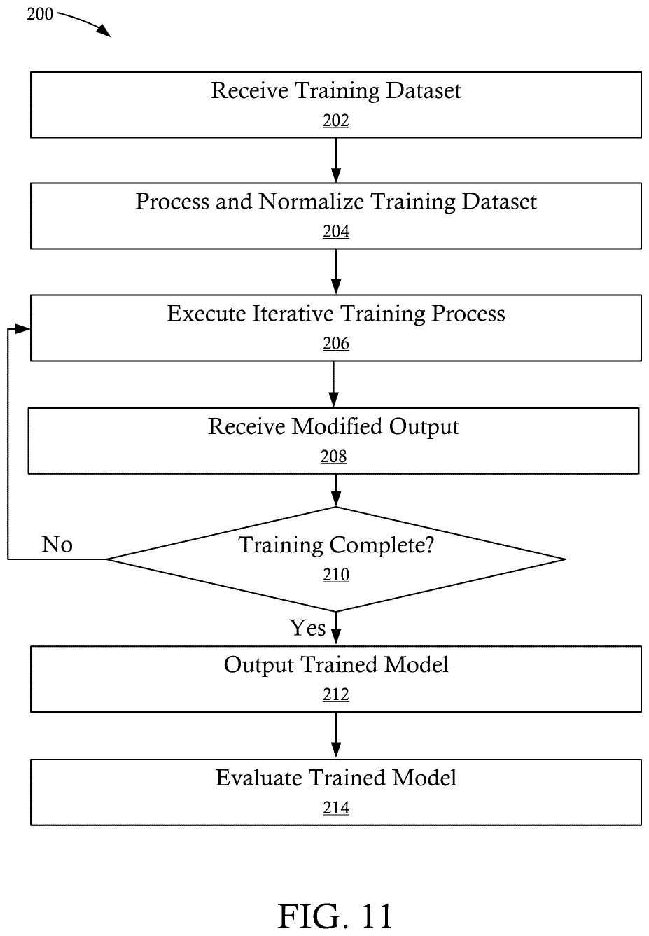

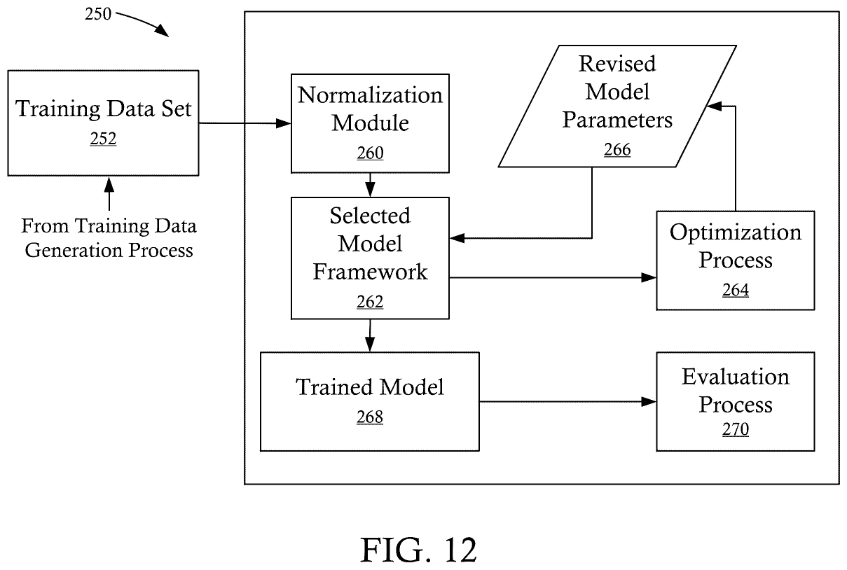

FIG. 10 illustrates a deep neural network (DNN) 170, in accordance with some embodiments. The DNN 170 is an artificial neural network, such as the neural network 100 illustrated in conjunction with FIG. 8, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( i ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

In some embodiments, a digital twin machine learning model can include and/or implement one or more trained models, such as a large language model (LLM). In some embodiments, one or more trained models can be generated using an iterative training process based on a training dataset. FIG. 2111 illustrates a method 20200 for generating a trained model, such as a trained image processing and evaluation of sets of digital files in accordance with multijurisdictional rules model, in accordance with some embodiments. FIG. 2212 is a process flow 25250 illustrating various steps of the method 20200 of generating a trained model, in accordance with some embodiments. At step 20202, a training dataset 25252 is received by a system, such as a processing device 10. The training dataset 25252 can include labeled and/or unlabeled data. For example, in some embodiments, a set of labeled and/or semi-labeled data/unlabeled data is provided for use in training a model, which may include results of evaluations of previous sets of documents.

At optional step 204, the received training dataset 252 is processed and/or normalized by a normalization module 260. For example, in some embodiments, the training dataset 252 can be augmented by imputing or estimating missing values of one or more features associated with sets of documents and criteria. In some embodiments, processing of the received training dataset 252 includes outlier detection configured to remove data likely to skew training of rules in the knowledge base. In some embodiments, processing of the received training dataset 252 includes removing features that have limited value with respect to training of the digital twin model.

At step 206, an iterative training process is executed to train a selected model framework 262. The selected model framework 262 can include an untrained (e.g., base) machine learning model, such as the digital twin model and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. In some embodiments, the cost value is related to time spent evaluating packages, and may also be related to faulty results such as packages deemed compliant that are nevertheless rejected by third party evaluators.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 208, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 210, a trained model 268, such as a trained large language model, is output and provided for use in a content extraction, such as the content extraction and tagging 200 discussed above with respect to FIGS. 6-7. At optional step 212, a trained model 268 can be evaluated by an evaluation process 270. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system configured to apply a digital twin model for multijurisdictional compliance via a dynamic, self-updating taxonomy based on real-time analysis of changing regulations, the system comprising:
a non-transitory memory;
a processor communicatively coupled to the non-transitory memory, wherein the processor is configured to read a set of instructions to:
train a digital twin machine learning model, wherein the digital twin machine learning model represents a physical asset configured to process digital files and apply criteria, and wherein the digital twin machine learning model is trained using a product taxonomy, a criteria knowledge base, and previous applications of the criteria to previous sets of digital files;
receive a set of digital files to determine whether the set of digital files meets one of a plurality of set completeness criteria, wherein each of the plurality of set completeness criteria includes digital file classification presence criteria and digital file completeness criteria;
apply image processing to the set of digital files to identify contents in each of the set of digital files;
analyze the set of digital files, using the digital twin machine learning model, including:
identify, using the contents of at least one digital file in the set of digital files, one of the plurality of set completion criteria to evaluate the set of digital files;
for each of the set of digital files:
determine, using the digital twin machine learning model, the classification of the respective digital file in accordance with the product taxonomy based on the content or metadata from the respective digital file;
determine, using the digital twin machine learning model, based on the digital file classification presence criteria associated with the classification, whether a digital file having the classification of the digital file is required;
upon a determination that a digital file having the classification of the digital file is required, determine whether the digital file meets the digital completeness criteria for the classification, based on the contents of the respective digital file as identified by the image processing;
in response to a determination that the respective digital file does not meet completion criteria, display on a user interface an identification of a required action for satisfying the completion criteria;
determine, using the digital twin machine learning model, whether the set of digital files meets the one of the plurality of set completion criteria, including: determining whether a digital file having each classification for which digital classification presence criteria are required is present and meets digital file completeness criteria for the classification;
upon a determination that the plurality of digital files does not meet the one of the plurality of set completion criteria, display on a user interface an identification of a rationale detailing why the set of digital files did not meet the one of the plurality of set completion criteria; and
upon a determination that the plurality of digital files meets the one of the plurality of set completion criteria, create an output reflecting that the set of digital files is complete.

2. The system of claim 1, wherein the knowledge base comprises a codified data structure based on file classification, file fields, and cross validation between digital files relating to a same one of a plurality of entities.

3. The system of claim 1, wherein the product taxonomy comprises a taxonomy mapping, wherein a plurality of form digital files, relating to each of a plurality of entities, is formed into a structural hierarchical format.

4. The system of claim 1, wherein determining the classification for each of the plurality of digital files in accordance with the taxonomy comprises using computer vision and artificial intelligence models based on metadata from the respective digital file, wherein the metadata is extracted and mapped.

5. The system of claim 4, wherein the processor is further configured to output the classification of each of the plurality of digital files into a tabular format.

6. The system of claim 1, wherein the output comprises submitting the plurality of digital files to an identified entity for approval, and, after a finding by the identified entity that a transaction was not approved, using the digital twin machine learning model to modify at least one of the plurality of set completion criteria or digital file completeness criteria, in accordance with information received from the identified entity in relation to the identified entity's refusal to approve the transaction.

7. A computer-implemented method for applying a digital twin model for multijurisdictional compliance via a dynamic, self-updating taxonomy based on real-time analysis of changing regulations, the computer-implemented method comprising:
training a digital twin machine learning model, wherein the digital twin machine learning model represents a physical asset configured to process digital files and apply criteria, and wherein the digital twin machine learning model is trained using a product taxonomy, a criteria knowledge base, and previous applications of the criteria to previous sets of digital files;
receiving a set of digital files to determine whether the set of digital files meets one of a plurality of set completeness criteria, wherein each of the plurality of set completeness criteria includes digital file classification presence criteria and digital file completeness criteria;
applying image processing to the set of digital files to identify contents in each of the set of digital files;
analyzing the set of digital files, using the digital twin machine learning model, including:
identifying, using the contents of at least one digital file in the set of digital files, one of the plurality of set completion criteria to evaluate the set of digital files;
for each of the set of digital files:
determining, using the digital twin machine learning model, the classification of the respective digital file in accordance with the product taxonomy based on the content or metadata from the respective digital file;
determining, using the digital twin machine learning model, based on the digital file classification presence criteria associated with the classification, whether a digital file having the classification of the digital file is required;
upon a determination that a digital file having the classification of the digital file is required, determining whether the digital file meets the digital completeness criteria for the classification, based on the contents of the respective digital file as identified by the image processing;
in response to a determination that the respective digital file does not meet completion criteria, displaying on a user interface an identification of a required action for satisfying the completion criteria;
determining, using the digital twin machine learning model, whether the set of digital files meets the one of the plurality of set completion criteria, including: determining whether a digital file having each classification for which digital classification presence criteria are required is present and meets digital file completeness criteria for the classification;
upon a determination that the plurality of digital files does not meet the one of the plurality of set completion criteria, displaying on a user interface an identification of a rationale detailing why the set of digital files did not meet the one of the plurality of set completion criteria; and
upon a determination that the plurality of digital files meets the one of the plurality of set completion criteria, creating an output reflecting that the set of digital files is complete.

8. The computer-implemented method of claim 7, wherein the knowledge base comprises a codified data structure based on file classification, file fields, and cross validation between digital files relating to a same one of a plurality of entities.

9. The computer-implemented method of claim 7, wherein the product taxonomy comprises a taxonomy mapping, wherein a plurality of form digital files, relating to each of a plurality of entities, is formed into a structural hierarchical format.

10. The computer-implemented method of claim 7, wherein determining the classification for each of the plurality of digital files in accordance with the taxonomy comprises using computer vision and artificial intelligence models based on metadata from the respective digital file, wherein the metadata is extracted and mapped.

11. The computer-implemented method of claim 7, further comprising outputting the classification of each of the plurality of digital files into a tabular format.

12. The computer-implemented method of claim 7, wherein the output comprises submitting the plurality of digital files to an identified entity for approval, and, after a finding by the identified entity that a transaction was not approved, using the digital twin machine learning model to modify at least one of the plurality of set completion criteria or digital file completeness criteria, in accordance with information received from the identified entity in relation to the identified entity's refusal to approve the transaction.

13. A non-transitory computer readable medium having instructions stored thereon, wherein the instructions, when executed by at least one processor, cause at least one device to perform operations to apply a digital twin model for multijurisdictional compliance via a dynamic, self-updating taxonomy based on real-time analysis of changing regulations, the operations comprising:
training a digital twin machine learning model, wherein the digital twin machine learning model represents a physical asset configured to process digital files and apply criteria, and wherein the digital twin machine learning model is trained using a product taxonomy, a criteria knowledge base, and previous applications of the criteria to previous sets of digital files;
receiving a set of digital files to determine whether the set of digital files meets one of a plurality of set completeness criteria, wherein each of the plurality of set completeness criteria includes digital file classification presence criteria and digital file completeness criteria;
applying image processing to the set of digital files to identify contents in each of the set of digital files;
analyzing the set of digital files, using the digital twin machine learning model, including:
identifying, using the contents of at least one digital file in the set of digital files, one of the plurality of set completion criteria to evaluate the set of digital files;
for each of the set of digital files:
determining, using the digital twin machine learning model, the classification of the respective digital file in accordance with the product taxonomy based on the content or metadata from the respective digital file;
determining, using the digital twin machine learning model, based on the digital file classification presence criteria associated with the classification, whether a digital file having the classification of the digital file is required;
upon a determination that a digital file having the classification of the digital file is required, determining whether the digital file meets the digital completeness criteria for the classification, based on the contents of the respective digital file as identified by the image processing;
in response to a determination that the respective digital file does not meet completion criteria, displaying on a user interface an identification of a required action for satisfying the completion criteria;
determining, using the digital twin machine learning model, whether the set of digital files meets the one of the plurality of set completion criteria, including: determining whether a digital file having each classification for which digital classification presence criteria are required is present and meets digital file completeness criteria for the classification;
upon a determination that the plurality of digital files does not meet the one of the plurality of set completion criteria, displaying on a user interface an identification of a rationale detailing why the set of digital files did not meet the one of the plurality of set completion criteria; and
upon a determination that the plurality of digital files meets the one of the plurality of set completion criteria, creating an output reflecting that the set of digital files is complete.

14. The non-transitory computer readable medium of claim 13, wherein the knowledge base comprises a codified data structure based on file classification, file fields, and cross validation between digital files relating to a same one of a plurality of entities.

15. The non-transitory computer readable medium of claim 13, wherein the product taxonomy comprises a taxonomy mapping, wherein a plurality of form digital files, relating to each of a plurality of entities, is formed into a structural hierarchical format.

16. The non-transitory computer readable medium of claim 13, wherein determining the classification for each of the plurality of digital files in accordance with the taxonomy comprises using computer vision and artificial intelligence models based on metadata from the respective digital file, wherein the metadata is extracted and mapped.

17. The non-transitory computer readable medium of claim 13, wherein the instructions further cause the at least one device to perform operations comprising outputting the classification of each of the plurality of digital files into a tabular format.

18. The non-transitory computer readable medium of claim 13, wherein the output comprises submitting the plurality of digital files to an identified entity for approval, and, after a finding by the identified entity that a transaction was not approved, using the digital twin machine learning model to modify at least one of the plurality of set completion criteria or digital file completeness criteria, in accordance with information received from the identified entity in relation to the identified entity's refusal to approve the transaction.
